(19) United States
(12) Patent Application Publication
(10) Pub. No.: US 2004/0181582 A1
(43) Pub. Date: Sep. 16, 2004

(54) Method of receiving an e-mail at mail server and sending a converted one therefrom

(75) Inventors: Cheng-Shing Lai, Taipei Hsien (TW); Pong Han, Nanking (CN); Shuang-Jun Xu, Nanking (CN)

Correspondence Address: BACON & THOMAS, PLLC, 625 SLATERS LANE, FOURTH FLOOR, ALEXANDRIA, VA, 22314

(73) Assignee: Inventec Appliances Corp., Taipei Hsien (TW)

(21) Appl. No.: 10/386,495

(22) Filed: Mar. 13, 2003

(51) Int. Cl. G06F 15/16

(52) U.S. Cl. 709/206; 709/246

(57) ABSTRACT

The present invention is to provide a method of receiving an e-mail at a mail server and sending a converted one therefrom comprising the steps of providing a conversion module in the mail server; and in response to a connection of a portable terminal to the mail server for receiving a compatible e-mail, enabling the mail server to activate the conversion module for converting the e-mail having a complex form unreadable by the portable terminal into a new e-mail having a simple form readable by the portable terminal; and sending the new e-mail to the portable terminal.

### FIELD OF THE INVENTION

The present invention relates to electronic mails (e-mails) sending and reading and more particularly to a method of receiving an e-mail at a mail server and sending a converted one from the mail server.

### BACKGROUND OF THE INVENTION

E-mails as a communication tool for replacing traditional mails between individuals and companies are very popular recently. One of the reasons for its popularity is because it can protect environment by reducing a consumption of paper. A gradually serious global warming effect can be effectively solved accordingly. Another reason is that many convenient application software are available on some information products having communication capability (e.g., desktop and notebook computers) and some portable terminals having communication capability (e.g., PDAs (Personal Digital Assistants), cellular phones, etc.). Further, such application software is more powerful by adding additional features therein. As such, an e-mail can contain a colorful, graphical text and files.

It is stipulated by the law that a user must buy an legal application software for lawfully installing it in the information product or the portable terminal. Accordingly, the user can run the application software to produce a document and store the same as a document file. The document file may be then appended in an e-mail prior to sending to another information product or portable terminal.

However, a user (i.e., recipient) at another information product or portable terminal may not have the same application software due to high price of the application software or needlessness. In other words, there is no such application software in another information product or portable terminal. Alternatively, software or hardware of another information product or portable terminal prohibits an installation of the application software therein. As such, the recipient at another information product or portable terminal will not be able to read the appended file of the e-mail because there is no way to run the application software. As a result, message contained in the e-mail will not be completely shown to the recipient. This can cause troubles and bring inconvenience. Hence, a need for improvement exists.

### SUMMARY OF THE INVENTION

A primary object of the present invention is to provide a method of receiving an e-mail at a mail server and sending a converted one therefrom comprising the steps of providing a conversion module in the mail server; and in response to a connection of a portable terminal to the mail server for receiving a compatible e-mail, enabling the mail server to activate the conversion module for converting the e-mail having a complex form unreadable by the portable terminal into a new e-mail having a simple form readable by the portable terminal; and sending the new e-mail to the portable terminal. By utilizing this method, a recipient at the portable terminal will be able to read the e-mail successfully.

The above and other objects, features and advantages of the present invention will become apparent from the following detailed description taken with the accompanying drawings.

### BRIEF DESCRIPTION OF THE DRAWINGS

FIG. 1 presents a structure of conversion table according to the invention; and

FIG. 2 is a flow chart illustrating a process according to the invention.

### DETAILED DESCRIPTION OF THE PREFERRED EMBODIMENTS

The invention is directed to a method of receiving an e-mail at a mail server and sending a converted one therefrom comprising the steps of providing a conversion module in the mail server, the conversion module including at least one simple form and a plurality of complex forms each corresponding to the simple form; and while the mail server connected with a plurality of portable terminals detecting that a portable terminal is going to receive the e-mail from the mail server, enabling the mail server to perform the sub-steps of activating the conversion module for converting the e-mail having a complex form unreadable by the portable terminal into a new e-mail having a simple form readable by the portable terminal; and sending the new e-mail having a simple form to the portable terminal. As a result, a recipient at the portable terminal will be able to read the e-mail successfully.

In the invention, the portable terminal issues a reading command to the mail server. After reading the reading command, the mail server processes an e-mail compatible with the portable terminal. Then e-mail is then sent back to the portable terminal after the subsequent processing. Note that there is an ID (identification) in the reading command. After reading the reading command, the mail server can determine whether the reading command comes from the portable terminal by identifying the ID. Finally, the mail server activates the conversion module if the determination is positive.

It is understood that a protocol (e.g., POP3 (Post Office Protocol Version 3)) must be carried out for signal sending or reading between the portable terminal and the mail server. In the embodiment, the protocol comprises a conversion layer for storing the ID as the portable terminal is sending the reading command. The mail server then uses the protocol to read the reading command. The mail server can determine whether the reading command comes from the portable terminal by identifying whether the ID exists in the conversion layer. Finally, the mail server activates the conversion layer if the determination is positive.

In the embodiment, the conversion module further comprises a reset program for limiting path and file name of the simple form stored in the mail server and redefining the structure of the complex form as one corresponding to that of the simple form. Hence, it can avoid a repeat of the filename, resulting in a facilitation of reading the e-mail by the mail server or the portable terminal. It also can convert the complex form into the simple form. Moreover, the reset program can directly delete the converted e-file for leaving space in the mail server.

In the invention, the complex form converted by the conversion module is an appended file of e-mail (e.g., the appended file having an extension of .doc, .rtf, or .ppd) unreadable by the portable terminal. For the conversion module, the simple form is an appended file of e-mail (e.g., the appended file having an extension of .html, or gif) of readable by the portable terminal. For the purpose of correctly converting an e-mail and ensuring the e-mail can be read by the portable terminal, text of the e-mail will be treated as one having a complex form if the text of the e-mail is unreadable by the portable terminal. To the contrary, the text of the e-mail will be treated as one having a simple form if the text of the e-mail is readable by the portable terminal.

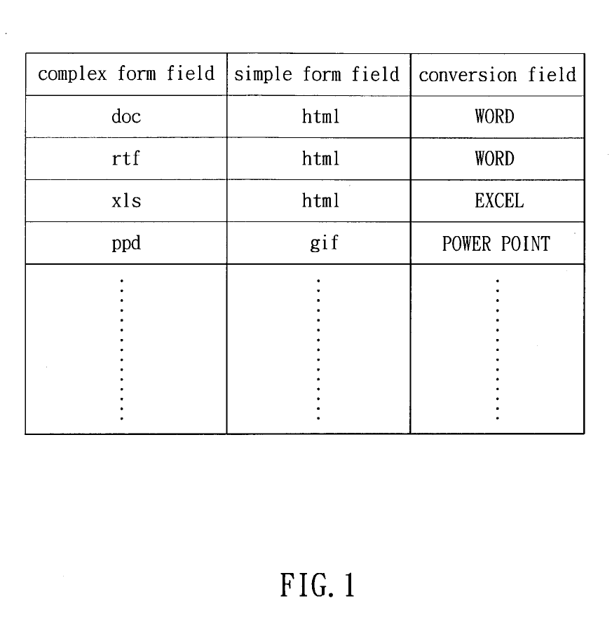

Referring to FIG. 1, there is shown a structure of conversion table in accordance with the invention. The conversion table is used to convert a complex form into a simple form. In detail, the conversion module comprises the conversion table including a plurality of complex form fields, a simple form field compatible with the complex form fields, and a conversion field. An extension of an appended file unreadable by the portable terminal is stored in each of the complex form fields. An extension of an appended file readable by the portable terminal is stored in the simple form field. A coding program for converting the complex form into the simple form is stored in the conversion field. The coding program can be one of a plurality of application programs (e.g., WORD, EXCEL, POWER POINT, etc. available by Microsoft Corp.) for the mail server.

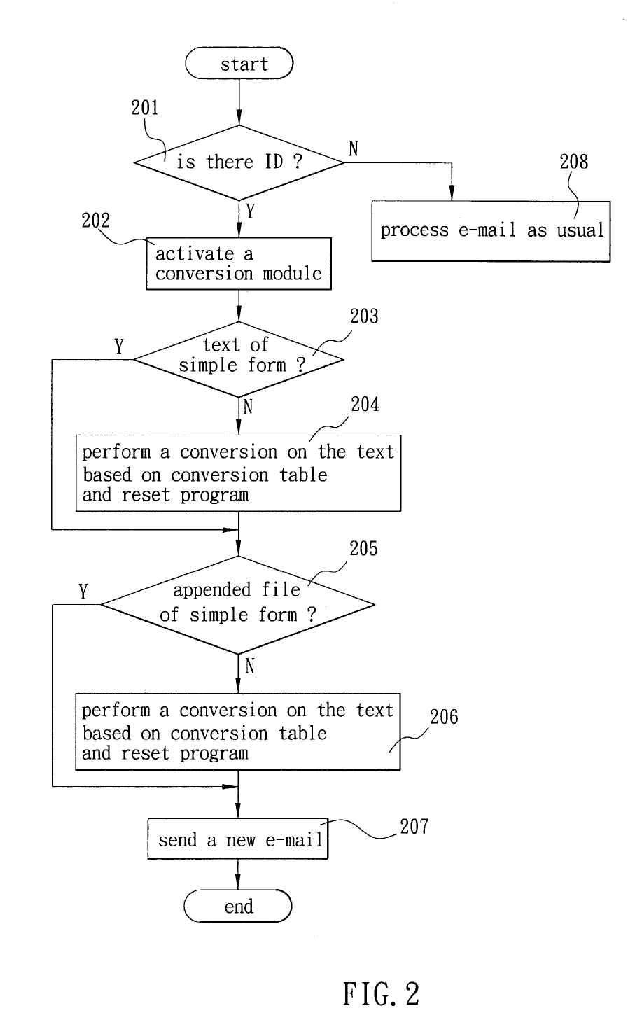

Referring to FIG. 2, there is shown a process performed by the mail server in response to a reading of the reading command. It comprises the following steps:

In step 201, it is determined whether there is an ID in the reading command. If yes, the process goes to step 202. Otherwise, the process jumps to step 208. In step 202, activate the conversion module. In step 203, it is determined whether text of the e-mail has a simple form. If yes, the process jumps to step 205. Otherwise, the process goes to step 204. In step 204, perform a conversion on the text of the e-mail based on the conversion table and the reset program. In step 205, it is determined whether an appended file of the e-mail has a simple form based on the conversion table. If yes, the process jumps to step 207. Otherwise, the process jumps to step 206. In step 206, perform a conversion on convert the appended file based on the conversion table and the reset program for obtaining a new e-mail having a simple form. In step 207, send the new e-mail having a simple form. The process ends immediately. In step 208, process the e-mail as usual.

While the invention has been described by means of specific embodiments, numerous modifications and variations could be made thereto by those skilled in the art without departing from the scope and spirit of the invention set forth in the claims.

What is claimed is:

1. A method of receiving an e-mail at a mail server and sending a converted one therefrom comprising the steps of:
providing a conversion module in the mail server, the conversion module including at least one simple form and a plurality of complex forms each corresponding to the simple form; and
while the mail server detecting a portable terminal is about to receive the e-mail therefrom, enabling the mail server to perform the sub-steps of:
activating the conversion module for converting the e-mail having a complex form unreadable by a portable terminal into a new e-mail having a simple form readable by the portable terminal; and
sending the new e-mail having a simple form to the portable terminal.

2. The method of claim 1, wherein the complex form converted by the conversion module is an appended file of the e-mail unreadable by the portable terminal, and the simple form is the appended file of the e-mail of readable by the portable terminal.

3. The method of claim 1, wherein a text of the e-mail will be treated as one having a complex form if the text of the e-mail is unreadable by the portable terminal or the text of the e-mail will be treated as one having a simple form if the text of the e-mail is readable by the portable terminal.

4. The method of claim 1, wherein the conversion module further comprises a reset program for limiting a path and a file name of the simple form stored in the mail server and redefining a structure of the complex form as one corresponding to that of the simple form.

5. The method of claim 4, wherein the reset program is capable of directly deleting a converted e-file for leaving space in the mail server.

6. The method of claim 1, wherein the portable terminal issues a reading command to the mail server so that after reading the reading command, the mail server processes the e-mail compatible with the portable terminal and sends the e-mail back to the portable terminal after the subsequent processing.

7. The method of claim 6, wherein the reading command comprises an ID so that after reading the reading command, the mail server determines whether the reading command comes from the portable terminal by identifying the ID and activates the conversion module if the determination is positive.

8. The method of claim 7, further comprising a protocol being used for signal sending or reading between the portable terminal and the mail server, the protocol including a conversion layer for storing the ID as the portable terminal is sending the reading command so that after the mail server using the protocol to read the reading command, the mail server determines whether the reading command comes from the portable terminal by identifying whether the ID exists in the conversion layer and activates the conversion layer if the determination is positive.

9. The method of claim 8, wherein the conversion module further comprises a conversion table including a plurality of complex form fields each for storing an extension of the appended file unreadable by the portable terminal, a simple form field compatible with the complex form fields for storing an extension of the appended file readable by the portable terminal, and a conversion field having a coding program for converting the complex form into the simple form, the coding program is selected from one of a plurality of application programs for the mail server so that in response to the reading of the reading command, the mail server performs the steps of:
(a) determining whether the ID exists in the reading command;
(b) if the determination in the step (a) is positive, activating the conversion module;
(c) determining whether the text of the e-mail has a simple form;
(d) if the determination in the step (c) is negative, performing a conversion on the text of the e-mail based on the conversion table and the reset program;
(e) determining whether the appended file of the e-mail has a simple form based on the conversion table;
(f) if the determination in the step (e) is negative, performing a conversion on the appended file for obtaining a new e-mail having a simple form; and
(g) sending the new e-mail having a simple form to the portable terminal.

10. The method of claim 9, wherein if the determination in the step (c) is positive, further comprises the sub-steps of:
(c1) determining whether the appended file of the e-mail has a simple form based on the conversion table;
(c2) if the determination in the step (c1) is negative, performing a conversion on the appended file for obtaining a new e-mail having a simple form; and
(c3) sending the new e-mail having a simple form to the portable terminal.
